(19) United States
(12) Patent Application Publication
(10) Pub. No.: US 2019/0114605 A1
(43) Pub. Date: Apr. 18, 2019

(54) POINT-OF-SALE PAYMENT AND COMMUNICATION SYSTEM

(71) Applicant: Renato Valencia, Muntinlupa City, Metro Manila (PH)

(72) Inventor: Renato Valencia, Muntinlupa City, Metro Manila (PH)

(21) Appl. No.: 15/509,191

(22) PCT Filed: Jun. 23, 2016
(86) PCT No.: PCT/IB2016/053754

§ 371 Date: Mar. 6, 2017

(51) Int. Cl. G06Q 20/20; G06Q 20/10; G06Q 20/40; G07F 11/00

(52) U.S. Cl. CPC G06Q 20/204; G07F 11/002; G06Q 20/40145; G06Q 20/102

(57) ABSTRACT

An embodiment of the invention provides an automated POS (point-of-sale) system which enables a payment transaction at a commodity vending apparatus or any computing device using an embedded or attached transaction device which may include an application serving as a POS reader accepting payment instruction from the vending apparatus for purchase of a good or service and a payment device which may be in the form of a plastic card with magnetic stripe, a plastic card with a chip, an RFID (radio frequency identification) card, an NFC (near field communication)-enabled mobile phone, an NFC-enabled SIM card or any similar device or any application. The transaction device generates and transmits to the payment device a payment request signal based on the payment instruction from the vending apparatus. The payment device associates financial account information with the payment request signal, and transmits to the transaction device a payment authorization signal based on the associated account information and payment request signal. The vending apparatus vends the product or service as and when it receives from the transaction device the payment authorization signal indicating that the payment transaction is successfully completed.

### TECHNICAL FIELD

The present invention generally relates to point-of-sale systems and, more particularly, to a point-of-sale system that enables performance of a payment transaction between a transaction device integrated into a commodity vending apparatus and a payment device in communication with one another.

### BACKGROUND ART

Conventionally, coins and bank notes are used to pay for goods or services at vending machines. Torn, wrinkled, deformed and ripped coins and bank notes are, however, invariably rejected by most vending machines. A situation where a purchaser has deteriorated bills at hand can result in a failure to perform a payment transaction at any vending machine and to dispense a product or service much desired by the purchaser.

John F. McCarthy, in his U.S. Pat. No. 9,043,237 published on 26 May 2015 to Fexco Merchant Services, discloses a system for making a payment using a wireless device such as a mobile phone. The prior system includes a merchant wireless point-of-sale device at a vending machine, a payment system that functions with one or more systems to perform a payment transaction, and the wireless device such as the mobile phone that captures a unique identifier of the payment transaction from the point-of-sale device and transmits the same to the payment system for authentication and authorization using either a default or user-selectable payment account of a customer initiating the payment transaction.

In performing the payment transaction, the payment system transmits account information, including account balance information, to the customer and receives an authorization from the customer to continue with the purchase. The system may automatically determine what accounts are appropriate for the transaction and present the account most appropriate for the transaction depending on previously inputted preferences of the user. This prior payment system also performs a security authentication check to verify that the customer and/or wireless device is associated with the payment account.

The prior payment system also receives coupon or voucher information that may be used to complete the payment transaction. For example, the customer may capture coupon information with the wireless device by scanning or photographing a barcode of the coupon, manually entering the barcode information, photographing or capturing an image of the coupon, downloading coupon information from a network (e.g., the internet), receiving coupon information via email and/or accessing an email having coupon information, receiving the coupon via wireless communication (e.g., NFC, Bluetooth) such as by placing the wireless device in close proximity to a system or device having coupon information, and the like.

This prior point-of-sale system, which involves wireless payment transaction and communications among electronic devices, arguably eliminates the need for a customer to carry coins and bank notes and, further, the occasion of vending operation failure arising from use of mutilated coins and bank notes.

However, a technical problem associated with this prior point-of-sale system is that the transmission of the account information and request for customer authorization from the payment system to the wireless device, and well as the customer authorization from the wireless device to the payment system, over a communication network causes the payment transaction to be conducted over a longer or extended period of time and to unnecessarily waste network resources allocated to the wireless device which acts as a payment device.

Thus, there remains an outstanding need for a point-of-sale system that enables performance of a payment transaction between a transaction device integrated into a product or service vending apparatus and a payment device in communication with one another wherein the payment transaction is conducted over a considerable shorter period of time and without unnecessarily wasting network resources allocated to the payment device.

### SUMMARY OF THE INVENTION

The following is a simplified summary of the disclosure associated with the invention in order to provide a basic understanding of one or more aspects of the same disclosure. This summary is not an extensive overview of the disclosure. It is intended to neither identify key or critical elements of the disclosure, nor delineate any scope of the particular embodiments of the disclosure or any scope of the appended claims. Its sole purpose is to present some concepts of the disclosure in a simplified form as a prelude to the more detailed description that is presented later.

An embodiment of the invention provides a POS (point-of-sale) system which enables performance of a payment transaction at a commodity vending apparatus using a transaction device, which may serve as a POS reader, and a payment device in communication with one another.

The payment device is in communication with a payment processing system over a first communication channel which may be a packet-based communication channel. The payment device is in communication with the transaction device integrated into the commodity vending apparatus over a second communication channel which may be an NFC (near-field communication) channel.

The transaction device may be arranged to receive and accept a payment instruction from the vending apparatus and to generate a payment request signal based on the payment instruction. Through the second communication channel which may be the NFC communication channel, the payment device may receive from the transaction device the payment request signal. The payment device, through a payment application or application program directly or indirectly embedded therein, can be used to associate financial account information with the payment request signal. The financial account information is related to a financial account which, by way of example, may be a deposit account.

In one illustrative embodiment of the invention, the payment device communicates with the payment processing system over the first communication channel which may be the packet-based communication channel such as the internet. Through a back-end payment processing and/or authorization operation, the payment processing system performs settlement and clearing operations or services for the payment transaction.

The payment processing system generates and transmits to the payment device a payment authorization signal over the first communication channel which is preferably the internet. The payment device outputs and transmits to the transaction device the payment authorization signal through the second communication channel which is preferably the NFC communication channel.

The vending apparatus vends a product or service as and when it receives from the transaction device, through appropriate circuitries associated with the vending apparatus and the transaction device, the payment authorization signal indicating that the payment transaction is successfully completed.

The provision of the payment device initiating a payment operation characterized by either a wired or wireless payment transaction by communicating with the payment processing system based on a request from a user ensures that settlement and clearing operations associated with the performance of the payment transaction are conducted independently of the vending apparatus and/or of the transaction device integrated into the vending apparatus. This provision comes with several technical advantages and benefits.

For one, authorization of the user who owns the account from which a transaction amount corresponding to the payment request signal is to be debited does not require additional series of communications or financial information exchange between the payment device and the vending apparatus. In effect, a considerable amount of time can be saved in completing and/or performing the payment transaction between the payment device and the vending apparatus and, more particularly, between the payment device and the transaction device integrated into the vending apparatus.

Since the settlement and clearing operations associated with the performance of the payment transaction are conducted independently of the vending apparatus and/or of the transaction device integrated into the vending apparatus, it also becomes apparent that the payment transaction can still be successfully completed even in cases where the vending apparatus and/or the transaction device integrated into the vending apparatus fails to communicate with a particular communication channel for facilitating settlement and clearing operations at the payment processing system or where there is no available communication channel at all at the time of performing the payment transaction.

Further, the payment processing system is not required to engage in a series of back-and-forth communications with the payment device just to obtain authentication and/or authorization of the user who owns the account from which the transaction amount is to be debited. This thereby avoids unnecessary usage of network resources allocated to the payment device like internet access which is commonly provided to internet subscriber accounts by internet service providers with various limitations.

For a better understanding of the invention and to show how the same may be performed, preferred embodiments thereof will now be described, by way of non-limiting examples only, with reference to the accompanying drawings.

### BRIEF DESCRIPTION OF THE DRAWINGS

FIG. 1 is a block diagram illustrating an exemplary point-of-sale system in accordance with an embodiment of the disclosure of the invention.

FIG. 2 is a flowchart illustrating an exemplary computer-implemented process according to some embodiments of the disclosure of the invention.

FIG. 3 is a schematic block diagram illustrating an exemplary hardware configuration of a payment device according to some embodiments of the disclosure of the invention.

FIG. 4 is a flowchart illustrating another exemplary computer-implemented process according to some embodiments of the disclosure of the invention.

FIG. 5 is a schematic block diagram illustrating an exemplary hardware configuration of a vending apparatus according to some embodiments of the disclosure of the invention.

FIG. 6 is a conceptual diagram illustrating an example environment in which the point-of-sale system may be applied according to some embodiments of the disclosure of the invention.

FIG. 7 is a flowchart illustrating yet another exemplary computer-implemented process according to some embodiments of the disclosure of the invention.

### DETAILED DESCRIPTION OF THE PREFERRED EMBODIMENTS

Embodiments of the present invention mainly provide a POS (point-of-sale) system which is generally designated by reference numeral 100 throughout the ensuing detailed description. These embodiments, their features and other aspects of the present invention are described in further and greater detail below.

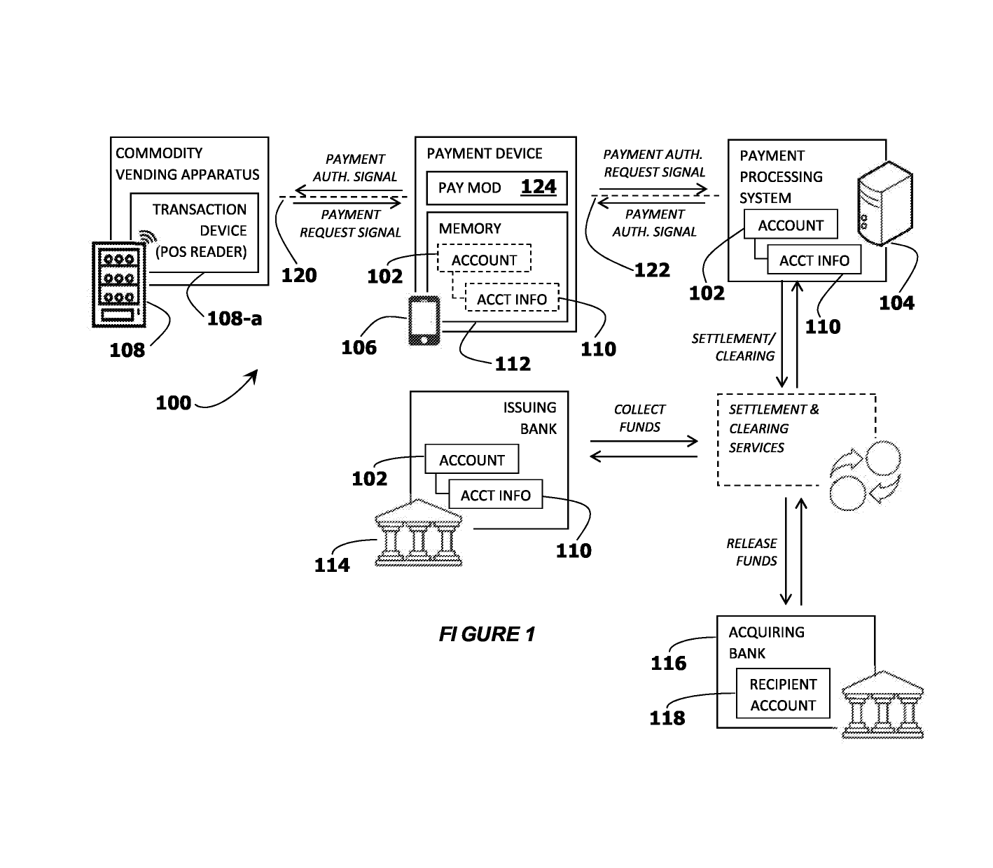

As shown in FIG. 1 which illustrates a block diagram of the architecture of the POS system 100 of the present invention, the POS system 100 includes at least one electronic account 102 held at an electronic payment processing system 104, a payment device 106 in operative communication with the payment processing system 104, and a transaction device 108-a in operative communication with the payment device 106.

The transaction device 108-a may serve as a POS reader and is preferably integrated into a vending apparatus 108 through appropriate circuitries and physical connections. The transaction device 108-a may include hardware, software, firmware, or any combination of the hardware, software and firmware.

The POS system 100 of the present invention, including various computer-implemented and/or computer-designed aspects, methods, processes, and configurations, may be implemented on a variety of electronic computing devices and systems, including electronic client devices and/or server computers, wherein these computing devices include the appropriate processing mechanisms and computer-readable media for storing, fetching, executing, and interpreting computer-readable instructions, such as programming instructions, codes, signals, and/or the like.

In addition, embodiments of the present invention may be implemented on existing controllers in control systems, computers integrated into, associated with and/or strategically positioned on the payment processing system 104, the payment device 106, the vending apparatus 108 and/or the transaction device 108-a.

Further, the POS system 100 of the present invention may include procedures for implementing logic control in programmable controllers in distributed control systems in wired or wireless networks that are owned and/or operated by one or more heterogeneous service providers or service companies.

All the ensuing disclosures and illustrations of the preferred embodiments of the POS system 100 of the present invention along with one or more components thereof, including mainly the payment processing system 104, the payment device 106, the vending apparatus 108 and the transaction device 108-a integrated into the vending apparatus 108 are merely representative for the purpose of sufficiently describing the manner by which the present invention may be carried out into practice in various ways other than the ones outlined in the ensuing description.

It is to be understood and appreciated by a person skilled in the art or having ordinary skills in the art, however, that the exemplary embodiments used to describe how to make and use the present invention may be embodied in many alternative forms and should not be construed as limiting the scope of the appended claims in any manner, absent express recitation of those features in the appended claims. All the diagrams and illustrations accompanying the ensuing description should also not be construed as limiting the scope of the appended claims in any manner.

It is also to be understood and appreciated that the use of ordinal terms like “first” and “second” is used herein to distinguish one element, feature, component, calculation or process step from one another and should not also be construed as limiting the scope of the appended claims, and that these and such other ordinal terms that may appear in the ensuing description are not indicative of any particular order of elements, features, calculations, components or process steps to which they are attached.

For example, a first element could be termed a second element. Similarly, a second element could be termed a first element. All these do not depart from the scope of the herein disclosure and its accompanying claims.

Unless the context clearly and explicitly indicates otherwise, it is to be understood that like reference numerals refer to like elements throughout the ensuing description of the figures and/or drawings, that the linking term “and/or” includes any and all combinations of one or more of the associated listed items, that the singular terms “a”, “an” and “the” are intended to also include the plural forms, and that some varying terms of the same meaning and objective may be interchangeably used.

The payment processing system 104 holding the electronic account 102 may include data processing networks, buses, devices, and other subsystems which host operations used to support and deliver end-to-end authorization services, exception file services, and as well as clearing and settlement services for financial assets, including bank deposits, currency, equity or debt securities, derivative products, and other negotiable instruments.

The payment processing system 104 may act as either a front-end payment processing system or a back-end payment processing system. The payment processing system 104 may also include middleware that works alone or in conjunction with mobile and/or web-based applications.

The payment processing system 104 may also hold at least one electronic account information 110 associated with the account 102. The account 102 may belong to, or owned by, a human depositor and may be issued by any card issuing institution or more commonly known as “issuer” in the banking industry.

In one embodiment, the payment processing system 104 is preferably an inter-bank network such as VisaNet™ and Banknet™. Payment processing systems such as VisaNet™ and Banknet™ are well known to be capable of processing credit card, debit card, and other types of commercial transactions.

VisaNet™, as is well known in the art, includes a VIP (Visa Integrated Payments) system which processes authorization requests and a Base II system which performs clearing and settlement services for financial derivatives and transactions between financial institutions such as banks.

The account 102 may be a financial account at such financial institution. This financial account may be a cash account, a credit account, a prepaid account, a savings account, a current account, a trust account, or an investment account.

For payment purposes, the account 102 may also be characterized by accounts which are related to, or associated with, loyalty cards, gift check cards, stored value cards, and the like.

The payment processing system 104 may include one or more server computers. Such a server computer is typically a single computer or a cluster of several computers.

For example, the server computer can be a large mainframe, a minicomputer cluster, or a group of servers functioning as a unit.

In one example, the server computer may be a database server coupled to a web server. The payment processing system 104 may use any suitable wired or wireless network, including the internet.

The payment device 106 is preferably a mobile telephone or mobile phone comprising a cellular radio transceiver, an NFC (near field communication) transceiver, a data storage, a user interface, input/output components, and an optional secure element.

Alternatively, the payment device 106 may be in the form of a plastic card with magnetic stripe, a plastic card with a chip, an RFID (radio frequency identification) card, and the like. Since these forms of the payment device 106 are not usually provided with capabilities to communicate through the first communication channel such as the internet, any front-end payment processing operation may be suitably adapted to support and enable the payment transaction at the vending apparatus 108.

The payment device 106 may correspond to the transaction device disclosed and illustrated in full detail in Philippine patent application no. 12015000261 filed with the Intellectual Property Office of the Philippines on 4 Aug. 2015 and published on 4 Apr. 2016 to United Sun Holdings, Limited, the full content of which is incorporated herein by reference in its entirety and for all purposes.

The secure element, which can be optional, may exist in a form factor selected from a group consisting of a UICC (Universal Integrated Circuit Card), an embedded SE (Secure Element) card, a smart SD (Secure Digital) card, and a smart micro SD (Secure Digital) card.

The payment device 106 may also include a memory component 112. The memory component 112 associated with the payment device 106 may contain the account 102 and the account information 110 from the payment processing system 104.

The account information 110 may relate to, or may be associated with, the account 102 held at the payment processing system 104 and contained in the memory component 112. The account 102 may be issued by the issuer.

The payment processing system 104 may act as a clearing house which performs settlement and clearing services between two or more financial institutions. These financial institutions may be, for example, a first bank 114 and a second bank 116 having their respective banking computer systems which are in operative communications with the payment processing system 104.

The first bank 114 may be an issuing bank or the “issuer” that issues the account 102 from which funds may be collected through the payment processing system 104. The second bank 116 may be an acquiring bank or “acquirer” with which a recipient account 118, distinct from the account 102, may be opened and maintained. The issuer 114 and the acquirer 116 may or may not be the same entity providing a wide range of financial products and services, among others.

The settlement and clearing services of the payment processing system 104 enable the release or transfer of the funds collected from the banking computer system of the issuer 114 to the computer banking system of the acquirer 116 through active private circuit lines, VPN (virtual private network) over the internet, specific messaging protocols, various APIs (application programming interfaces), electronic portals and/or other electronic communications protocol for real-time exchange of information.

Any communication network with similar protocols can be used to operatively connect the payment processing system 104 to any one or each one of the banking computer systems of the issuer 114 and the acquirer 116 for authorization, settlement and clearing, among others. Each of the banking computer systems of the issuer 114 and the acquirer 116 may include one or more clusters of computers capable of communicating with one another.

It is to be understood and appreciated that the payment device 106 may engage in a variety of communication exchanges with other payment devices or data communication devices.

It is to be understood and appreciated that the POS system 100 of the present invention can be implemented either as a closed-loop system or otherwise as an open-loop payment system.

The closed-loop payment system (e.g., Oyster™, Octopus™, and the like) requires one party to issue, settle or process, and acquire. The open-loop payment system (e.g., Visa™, Mastercard™, and the like), on the other hand, enables multi-issuers, multi-acquirers, multi-processors or multi-settlement banks to interact with one another.

It is also to be understood and appreciated that one or more components of the POS system 100 of the present invention, such as the payment device 106, the transaction device 108-a and/or any computing device operatively connected to the vending apparatus 108 that performs substantially the same function as that of the transaction device 108-a, may utilize either a closed operating system (e.g., Apple™, Windows™) or an open operating system (Android™, Linux™) for operating applications or application programs and performing payment transactions based on the configurations of these applications or application programs.

It is also to be understood and appreciated that the payment device 106 may be implemented as a variety of devices other than the mobile phone such as a PDA (personal digital assistant), a media player, a laptop computer, a tablet computer, a notebook computer, a netbook computer, and other electronic devices having physical resources which support short-range, medium-range and/or long-range radio communications, and as well as wired or wireless packet-based data communications.

The vending apparatus 108 may be constructed to have a vessel and electromechanical controllers and/or arrangements (not illustrated) disposed inside the vessel, both of which cooperate with one another to vend or dispense various articles. Vending operations which are well known in the art may be utilized for the vending of various articles by the vending apparatus 108.

Such articles may include refrigerated products such as containerized beverages like soda, coffee and milk, baked products such as cake, pasta and biscuits, sanitary consumer products such as tissues, napkins, panty liners, tampons, condoms, incontinence pads, diapers, liquid soap, alcohol and toothpaste, ticket or card based products such as cinema passes, theatre passes, carpark passes, membership passes, event passes, grocery vouchers, discount coupons, and the like.

The vending apparatus 108 may also be arranged to vend various services which may include bills payment services, Telco prepaid account loading services, corporate payout services, internet access services, game play services, video play services, television channel access services, computer program download and/or access services, movie download and/or access services, pay-per-view services, multimedia download and/or access services, concierge services, and services relating to conferences, seminars, webinars, lectures, lessons, classes, tutorials, sports, tournaments, socials, political activities and any other type of events.

The services that can be provided through the vending apparatus 108 may also include entertainment services, spa services, health services, dining services, product delivery services, cargo shipping services, flight booking services, hotel booking services, travel booking services, vehicle rental services, equipment rental services, reservation services, trading services, dating services, job search services, and employment services.

It is to be understood and appreciated that the POS system 100 of the present invention may also be utilized in a “utility” station or terminal. The term “utility” may refer to any commodity that can be provided by a utility provider to a consumer. Within certain geographical area, utility providers typically provide the general public consisting of consumers with one or more commodities offered for sale.

Utility stations are usually arranged by these utility providers for dispensing and/or distribution of various commodities such as, but not limited to, community water, electrical power, fuel, oil, transportation services, communication services which may be integrated into the form of telephone booths, medical goods and services, and cable television services.

The vending apparatus 108 that dispenses any one of these and such other goods and/or services may be located off-site or on-site, or may have off-site or on-site communication links. In off-site location, the vending apparatus 108 can be arranged such that the transaction device 108-a incorporated thereinto can send a payment request signal to any computing device with POS processing capabilities over any suitable communication network.

Utility providers typically regulate the dispensing and/or distribution of the aforementioned commodities, wherein consumers are provided with “utility accounts” set up by the utility providers. The utility accounts may be used to track the utility usage and/or consumption of the consumers at a certain geographical area. Utility bills may be provided to the consumers by the utility providers using these utility accounts.

The POS system 100 of the present invention may be operably configured in any utility stations or terminals maintained and managed by the utility providers such that consumers can use the POS system 100 for facilitating settlement or payment of the consumers' utility bills in real-time or near real-time.

One or more communication channels may be utilized by the POS system 100 of the present invention. In some embodiments, the POS system 100 of the present invention may include first and second communication channels 122, 120. Any one or both of the first and second communication channels 122, 120 may have wired or wireless operating conditions.

In one or more embodiments, the transaction device 108-a integrated into the vending apparatus 108 is in operative communication with the payment device 106 over the second communication channel 120.

The transaction device 108-a may be strategically built-in (e.g., embedded or attached) with the vending apparatus 108. Alternatively, the embedded or attached transaction device 108-a may be removably attachable to the vending apparatus 108 or any computing device associated with vending of any commodity.

The transaction device 108-a serving as the POS reader may comprise contact or contactless reading technologies that can be provided with security protocols and other related means for performing authentication, ciphering, deciphering, hashing and performing integrity checks, among others.

The transaction device 108-a may be a miniature physical POS device or unit, preferably of a size which is smaller than that of a typical dongle known in the art, that can be embedded in any computing device, mobile phone, or similar device capable of reading transaction data from any form of the payment device 106. For example, the transaction data that can be read by the transaction device 108-a integrated into the vending apparatus 108 may originate from a plastic card with magnetic stripe or from a mobile phone with NFC-enabled SIM card.

Alternatively, or in conjunction with the physical POS device or unit, the transaction device 108-a may be characterized by a portable application or application program that can be embedded in any computing device that supports payment processing and communication systems together with identification of identities of users, purchasers, vendors and/or merchants.

The transaction device 108-a, which accepts payment instructions from the vending apparatus 108 and which may be arranged to read, identify and/or verify all transaction data from the payment device 106, may be implemented as any one or any suitable combination of a transceiver, a transponder, an interrogator, a scanner, a terminal, a tag, a beacon, a chip, a circuit board and the like.

Preferably, the second communication channel 120 is any NFC (near field communication) channel operating in accordance with NFC standards. Correspondingly, the transaction device 108-a may be, or may include, an NFC reader which is capable of reading all transaction data passing through the NFC channel.

In another embodiment, the transaction device 108-a integrated into the vending apparatus 108 may be arranged to support NFC peer-to-peer mode of communication based on ISO 18092. The NFC peer-to-peer mode of communication may be arranged in an active mode or passive mode.

Through the NFC peer-to-peer mode of connection, a bidirectional connection for use in exchange of all transaction data can be established between the NFC-enabled payment device 106 and the transaction device 108-a which serves as the NFC reader.

Through the NFC peer-to-peer mode of connection, it is to be understood and appreciated that any of the NFC-enabled payment device 106 and the NFC-enabled transaction device 108-a integrated into the vending apparatus 108 may be set as a client (acting as NFC peer-to-peer initiator) or a host (acting as NFC peer-to-peer target), and that the transaction data which mainly include financial and identification data between the payment device 106 and the transaction device 108-a may be represented as NDEF (NFC Data Exchange Format).

It is to be understood and appreciated, however, that other short-range to medium-range radio communication channels, links or networks utilizing proximity-based services may also be used for facilitating the communication between the transaction device 108-a and the payment device 106.

For example, the short-range communication between the transaction device 108-a and the payment device 106 may include IR (Infrared) communication, Bluetooth™ communication, BLE (Bluetooth™ low energy) communication, Wi-Fi (Wireless Fidelity) communication, active RFID (radio frequency identification), passive RFID, IEEE 802.15.4, Zigbee communication, Z-wave communication, and UWB (ultra-wideband) communication.

UHF (ultra high frequency) communications and VHF (very high frequency) communications may also be utilized in facilitating such short-range to medium-range communications.

In one or more embodiments, the payment device 106 is in operative communication with the payment processing system 104 over the first communication channel 122. Preferably, the first communication channel 122 is a packet-based communication channel which may be wireless or wired.

The first communication channel 122, by way of examples and not by way of limitation, may be a data communication network operating as a 3GPP (3rd Generation Partnership Project), 4G (fourth generation) or LTE (long term evolution), LTE-advanced network, a 5G (fifth generation), or other cellular phone network.

In some embodiments, the network characterizing the first communication channel 122 may include a WAN (wide area network), a MAN (metropolitan area network), the internet, a fiber optic-based network, and/or a combination of these or other types of data communication networks which are well known in the art.

In some embodiments, the network may also be implemented based on other standards, such as the CDMA (Code Division Multiple Access) wireless network, the 2G (second generation) wireless network, the 3G (third generation) wireless network, the 5G (fifth generation) wireless network, any IEEE 802.11 based wireless network and/or another wireless network. In some other embodiments, the network may be communicatively coupled to one or more other wired or wireless networks.

In operation, the vending apparatus 108 may be operated, managed and/or maintained by a merchant. However, it is to be understood and appreciated that the vending apparatus 108 of the POS system 100 of the present invention does not require a human operator to initiate and/or process electronic payments since the POS system 100 of the present invention is fully automated in wired and/or wireless environments. In other words, the vending apparatus 108 into which the transaction device 108-a is preferably integrated may be an unmanned vending machine or any similar structure or machine of similar configuration.

In one embodiment, the vending apparatus 108 may be arranged such that it dispenses containerized beverages which are offered for sale. Revenues associated with the sale of the containerized beverages may proceed to the recipient account 118 of the merchant. The recipient account 118 may be maintained at the acquirer, and may be a deposit account.

The payment device 106 may be used and operated by a purchaser who is interested in purchasing any one of the containerized beverages offered for sale at the vending apparatus 108. At any moment that the purchaser desires to initiate the purchase, the purchaser may perform a commodity selection wherein the commodity includes the containerized beverages.

The vending apparatus 108 may then generate a commodity selection request signal based on the commodity selection of the purchaser and consequently a payment instruction which corresponds to the commodity selection request signal.

The vending apparatus 108 may transmit to the transaction device 108-a the payment instruction through appropriate circuitries associated with the vending apparatus 108 and the transaction device 108-a.

In response to receipt of the payment instruction from the vending apparatus 108, the transaction device 108-a may generate a payment request signal. The payment request signal may, in whole or in part, correspond to the payment instruction originating from the vending apparatus 108.

The transaction device 108-a may be arranged to transmit to the payment device 106, preferably over the NFC channel 120, the payment request signal which is effectively based on the commodity selection request signal generated by the vending apparatus 108 in response to a request from the purchaser.

The transmission of the payment request signal from the transaction device 108-a to the payment device 106 may be effectively performed when the payment device 106 is placed in a location proximate to the transaction device 108-a which is preferably integrated into the vending apparatus 108.

Generally, in response to receipt of the payment request signal from the transaction device 108-a, the payment device 106 associates the account information 110 with the payment request signal, consequently outputs a payment authorization signal based on the associated account information 110 and payment request signal, and finally transmits back to the transaction device 108-a the payment authorization signal.

The account information 110 are associated, in whole or in part, with the account 102 selected by the purchaser of the good or service offered for sale at the vending apparatus 108 of the POS system 100 of the present invention.

The payment authorization signal may be outputted by the payment device 106 based either on clearing and settlement services via a back-end payment processing and/or authorization operation or, otherwise, on pre-approved value or balance via a front-end payment processing and/or authorization operation.

The preferred payment processing and/or authorization operations, and how they can be performed, shall be discussed in greater detail in the ensuing description of the POS system 100 of the present invention in accordance with some implementations.

The payment request signal with which the account information 110 is associated may include unique transaction identifier information uniquely identifying the payment transaction corresponding to the payment request signal.

The payment request signal may also include transaction date information, transaction time information, commodity description information, commodity quantity information, commodity price information or “transaction amount” information, commodity tax information and/or location information, all of which are preferably viewable by the purchaser on the viewing screen or display screen of the payment device 106 if the payment device 106 is in the form of an NFC-enabled mobile phone.

The payment request signal may also include merchant account information which may or may not be viewable by the purchaser on the display screen of the payment device 106, as the merchant account information may be held confidential and not readily viewable through any third party computing system.

The payment request signal may be processed by a payment module 124 residing on the payment device 106. The payment module 124 may be created in any suitable platform using any appropriate programming language such as Java and PHP.

Through a payment interface associated with the payment module 124, the purchaser may select the account 102, or any other account which the purchaser maintains at any financial institution and which is registered with the payment module 124, to which she desires the purchase price information or the transaction amount associated with the payment request signal to be deducted or debited. The commodity tax information may be included in the purchase price information.

The payment module 124 may include a payment application which may reside either on the memory component 112 of the payment device 106 or on a secure element-based memory component associated with the secure element. The secure element-based memory component may contain the account information 110 related to the account 102.

The payment application in the payment device 106 of the POS system 100 of the present invention may correspond to the payment application disclosed and illustrated in full detail in Philippine patent application no. 12015000261 which is incorporated herein by reference in its entirety and for all purposes.

The payment application or payment application program may work dependently or independently of the physical structure of the payment device 106. In one embodiment, the payment application or payment application program forms part of the physical structure of the payment device 106 and/or of the secure element of the payment device 106.

The secure element may be in operative communication with one or more hardware components of the payment device 106. Preferably, the secure element may be a SIM (subscriber identification/identity module) card which is well-known in the fields of electronics and communications.

The secure element of the POS system 100 of the present invention may correspond to the integrated circuit device disclosed and illustrated in full detail in Philippine utility model registration no. 22016000120 filed with the Intellectual Property Office of the Philippines on 2 Mar. 2016 and published on 2 Mar. 2016 to United Sun Holdings, Limited, the full content of which is likewise incorporated herein by reference in its entirety and for all purposes.

Using the payment application or application program of the payment module 124, and either through the back-end payment or front-end payment processing operations and/or authorization services, the purchaser may readily confirm and, in turn, authorize the payment transaction represented by the payment request signal from the transaction device 108-a. The purchaser may review any of the information associated with the payment request signal.

If any discrepancies are observed by the purchaser, the payment transaction may be discontinued by the purchaser. In that case, the purchaser may choose to restart from the commodity selection at the vending apparatus 108 for a change in purchase request or, otherwise, to completely abandon the transaction.

If all the information associated with the payment request signal are accurate, according to one embodiment of the present invention, the payment application may be caused by the purchaser to generate a payment authorization request signal based on the associated account information 110 and payment request signal.

The payment device 106, prior to outputting of the payment authorization signal, may transmit to the payment processing system 104, preferably over the first communication channel 122 which may be the internet, the payment authorization request signal from which the payment authorization signal may be based.

Clearly, the authorization of the purchaser to use her account 102 for the payment transaction is initiated by her through the payment device 106 and not through any other devices or computing systems of which she has no control. Also in that case, the payment processing system 104 does not have to communicate back with the payment device 106 just to ask for any required authentication and/or authorization details during the back-end payment processing operations and/or services.

The payment processing system 104 may then perform authorization, settlement and clearing operations in response to the payment authorization request signal it receives from the payment device 106 over the first communication channel 122. The authorization, settlement and clearing operations are applied by the payment processing system 104 against the accounts 102, 118 at the issuer 114 and at the acquirer 116, respectively.

The payment authorization signal is generated by the payment processing system 104 once the settlement and clearing operations are successfully concluded, finalized and completed, effectively collecting electronic funds corresponding to the purchase price information or the transaction amount from the account 102 of the purchaser maintained at the issuer 114 and releasing the same to the recipient account 118 of the merchant maintained at the acquirer 116. Communications among the payment processing system 104 and each of the computer systems of the issuer 114 and acquirer 116 may be conducted through the internet.

The payment authorization signal is transmitted from the payment processing system 104 to the payment device 106 over the first communication channel 122 which may be the internet.

Upon receipt from the payment processing system 104 of the payment authorization signal generated by the payment processing system 104 based on the payment authorization request signal, the payment device 106 outputs and transmits to the transaction device 108-a integrated into the vending apparatus 108 the same payment authorization signal over the second communication channel 120 which may be the NFC channel or such other short to medium range communication channel.

The payment authorization signal may then be transmitted from the transaction device 108-a to the vending apparatus 108. In response to the payment authorization signal which the vending apparatus 108 receives from the transaction device 108-a and which indicates that the payment transaction is successfully completed, the vending apparatus 108 vends a commodity, which may be a tangible product or an intangible service, based on the commodity selection request signal from which the payment authorization signal is originally derived.

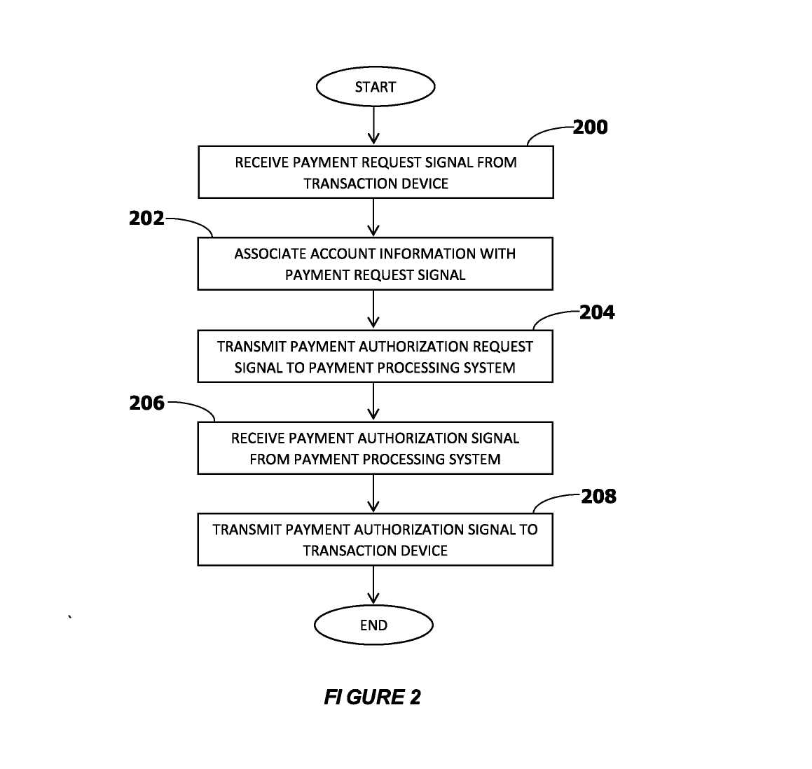

Referring now to FIG. 2, there is shown a flowchart illustrating an exemplary computer-implemented process according one or more embodiments of the present invention. The process illustrated in FIG. 2 is preferably performed and carried out by the payment device of the POS system of the present invention.

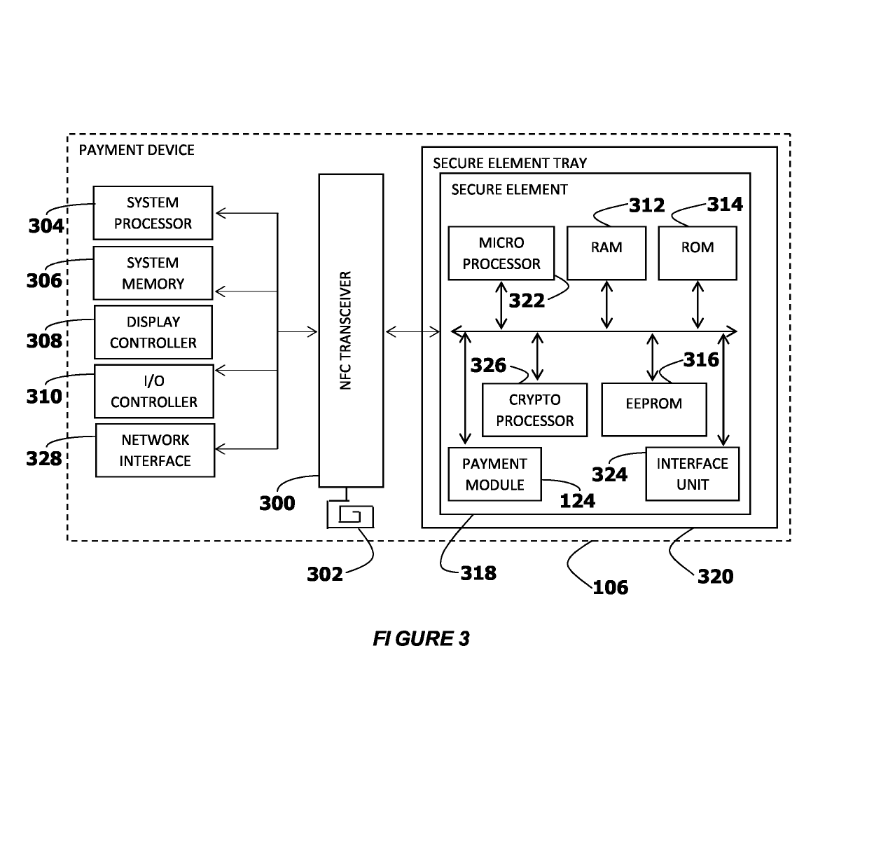

An exemplary hardware architecture of the payment device according to one or more embodiments of the present invention is illustrated in the schematic diagram shown in FIG. 3.

With more particularity, the process illustrated in FIG. 2 may be carried out or performed by the payment device through its hardware components illustrated in FIG. 3.

The process commences by receiving the payment request signal from the transaction device which is preferably integrated into the vending apparatus, as shown in step 200.

The payment request signal may be based on the payment instruction generated by the vending apparatus in response to the purchase request from the purchaser. The purchase request may correspond to the commodity selection request signal.

The payment request signal may be received by the payment device 106 from the transaction device integrated into the vending apparatus over the NFC channel via the NFC transceiver 300 having the NFC antenna 302.

The NFC transceiver 300 of the payment device 106 may be used to transmit and/or receive signals from and/or in the direction of the transaction device or may be arranged to support NFC peer-to-peer mode of connection or communication.

The NFC transceiver 300 is electronically communicating with the system processor 304. The system processor 304 is in operative communication with the system memory 306, the display controller 308, and the I/O (input/output) controller 310 through appropriate buses and circuitries.

Subsequently, the process advances to step 202 wherein the payment device 106 associates the account information with the payment request signal originating from the transaction device integrated into the vending apparatus.

The account information may be stored on the system memory 306 of the payment device 106. The account information may be retrieved from the system memory 306 by the system processor 304, and may be displayed on a display screen of the payment device 106 via the display controller 308.

Alternatively, the account information may be stored on any or each of the memory components 312, 314, 316 of the secure element 318. The secure element 318 can be inserted into the secure element tray 320 of the payment device 106.

The secure element 318 may be electrically coupled to the payment device 106. Through this electrical connection, the secure element 318 and the payment device 106 may share data and/or hardware and/or software resources with one another.

The memory components 312, 314, 316 may include any one or more of the RAM (random access memory) 312, ROM (read-only memory) 314, and EEPROM (electrically erasable programmable read-only memory) 316, to name but a few.

In one embodiment, the account information may be retrieved from the non-volatile EEPROM 316 by the microprocessor 322, and may be accessed through the interface unit 324 of the secure element 318.

The secure element 318 may also include a crypto-processor 326 arranged to perform encryption and/or decryption operations against messages that the secure element 318 receives through the interface unit 324.

These messages may be encoded in signals originating from and/or destined to the vending apparatus over the NFC channel. These messages may also be encoded in signals originating from and/or destined to the payment processing system over an internet communication channel.

The secure element 318 may include the payment module 124. The payment module 124 may execute any pre-arranged payment application or payment application program.

The payment application program of the payment module 124 records all payment transactions and enables a purchaser to select one of her financial accounts if she has two or more of such accounts registered with the payment module 124.

Alternatively, the payment module 124 may also exist in the system memory 306 of the payment device 106 outside the structure of the secure element 318.

Once the account information has been associated with the payment request signal by the payment device 106, the process moves to step 204 wherein the payment device 106 transmits payment authorization request signal to the payment processing system over the internet or any other suitable communication network of the same nature and configuration.

In effecting the payment authorization request, the payment module 124 may require authentication details, such as security passcodes or passwords, digital secure keys, QR (Quick Response) codes or 2D (two-dimensional) bar codes, and as well as NFC tags, to ensure that the real owner of the financial account is requesting the payment authorization whereby potential fraud is prevented.

The payment device 106 may also include a biometric sensor (not illustrated) that can be used by the payment module 124 to authenticate the identity or the legitimacy of the purchaser requesting for the payment authorization.

The biometric sensor may include, palm sensors for palm vein pattern recognition, hand sensors for hand geometry recognition, handwriting sensors for signature recognition, voice sensors for voice recognition, and the like.

The biometric sensor may further include, but not limited to, face sensors for facial attribute recognition, speech sensors for speech recognition, optical measurement based sensors for iris pattern recognition, corneal pattern recognition and retinal scan, and as well as fingerprint sensors for fingerprint scan.

The authentication may also be based on gesture or motion sensors for gesture or motion recognition.

It is to be understood and appreciated that biometric measurements of any of other body features of the user or purchaser may also be utilized in authenticating the identity of the same purchaser requesting the payment authorization.

The biometric information captured by the biometric sensor and such other related sensors may correspond to the identifying characteristics of the individual human purchasers. Put differently, these natural characteristics or parameters can be utilized to identify, verify and/or authenticate identity and/or personal information of the individual human purchasers.

The payment processing system may be remotely located relative to the payment device 106.

The payment processing system may independently operate, or may perform computing operations, procedures, functions, and routines, in a distributed environment.

The transmission of the payment request signal from the payment device 106 to the payment processing system may be performed via the network interface 328 of the payment device 106 of the POS system of the present invention.

Once the payment authorization signal has been generated at the payment processing system, the payment device 106 may receive the same payment authorization signal from the payment processing system over the internet communication channel and via the network interface 328, as shown in step 206.

Consequently, and in accordance with an embodiment, the payment device 106 may output and transmit to the transaction device which is integrated into the vending apparatus the payment authorization signal over the NFC channel via the NFC transceiver 300 having the NFC antenna 302, as shown in step 208.

The transmission of the payment authorization signal from the payment device 106 to the transaction device may be realized when these two devices are in close proximity to one another.

The NFC transceiver 300 may include controllers and logic for enabling NFC communications which are well known in the art.

The NFC transceiver 300 may be arranged to process both incoming and outgoing NFC related transactions.

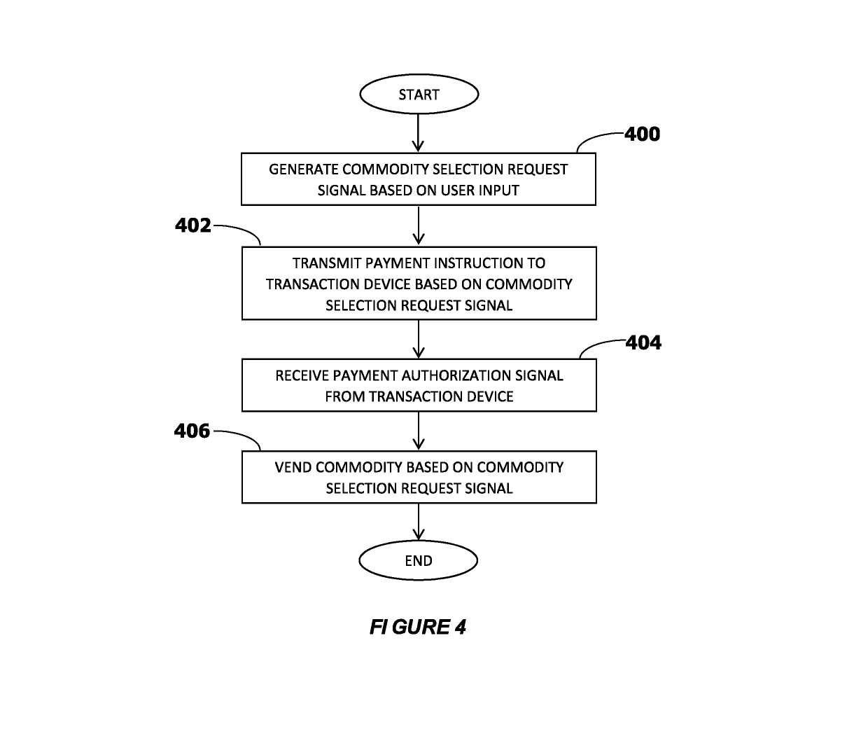

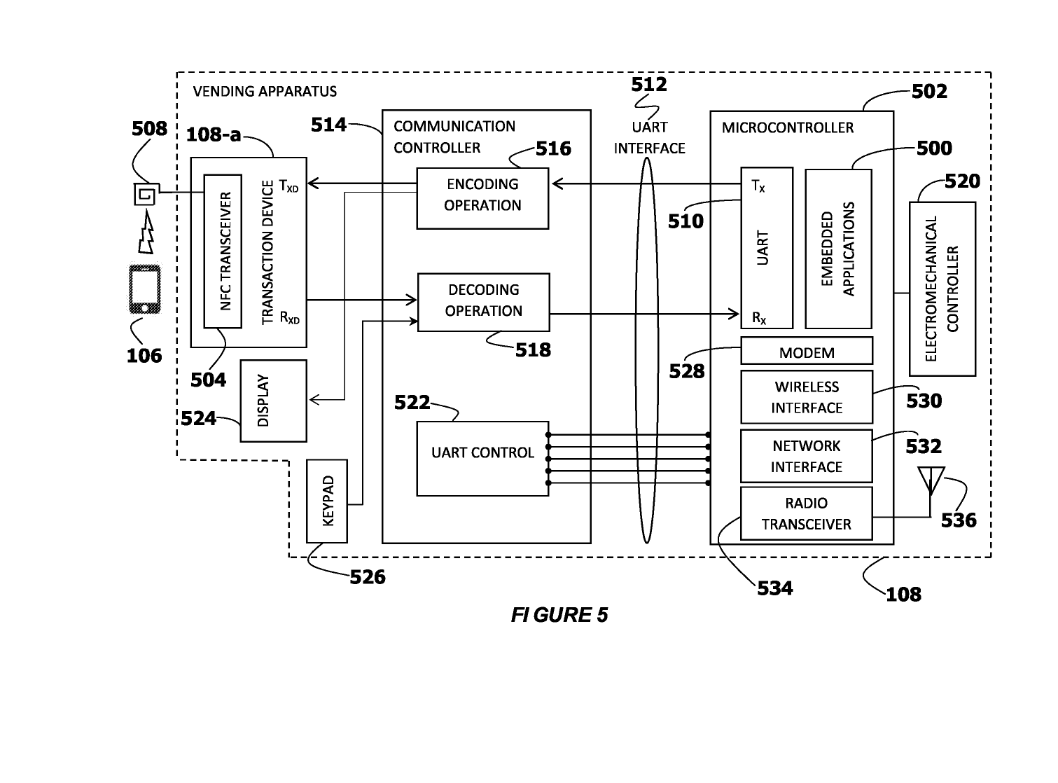

Referring now to FIGS. 4 and 5, there are shown, respectively, a flowchart illustrating another exemplary computer-implemented process according to some embodiments of the disclosure of the present invention, and a schematic block diagram illustrating an exemplary hardware configuration of the vending apparatus 108 according to some embodiments of the disclosure of the present invention.

With more particularity, the process illustrated in FIG. 4 may be carried out or performed by the vending apparatus 108 through its hardware configuration illustrated in FIG. 5.

At step 400, the vending apparatus 108 generates commodity selection request signal based on user input. The user input may correspond to the input of the purchaser wherein the input is indicative of the particular commodity (i.e., a product or a service) for sale at the vending apparatus 108.

The generation of the commodity selection request signal may be performed and/or conducted through the embedded applications or embedded application programs 500 residing on the microcontroller 502 of the vending apparatus 108.

At step 402, the vending apparatus 108 generates and transmits to the transaction device 108-a (which may be, or may include, an NFC transceiver or NFC reader) the payment instruction through appropriate circuitries and physical connections and based on the commodity selection request signal.

The transaction device 108-a may then generate and transmit to the payment device 106 the payment request signal based on the payment instruction from the vending apparatus 108.

The transmission of the payment request signal from the transaction device 108-a integrated into the vending apparatus 108 to the payment device may be conducted via the NFC transceiver 504 having the NFC antenna 508 of the transaction device 108-a. Alternatively, the NFC transceiver 504 having the NFC antenna 508 may form part of the vending apparatus 108, separate from the transaction device 108-a.

In the same manner, via the NFC transceiver 504 having the NFC antenna 508, the transaction device 108-a may receive the payment authorization signal from the payment device 106 which is NFC-enabled, as shown in step 404.

The NFC transceiver 504 may serve as NFC reader for reading all incoming transactions. The NFC transceiver 504 of the vending apparatus 108 serving as the NFC reader may be arranged to support NFC peer-to-peer mode of connection.

The commodity selection request signal from which the payment instruction and the payment request signal are derived may originate from the UART (universal asynchronous receiver/transmitter) 510 through the UART interface 512. The UART 510 may reside on the microcontroller 502.

The vending apparatus 108 may include a communication controller 514 which may perform an encoding operation 516 for and against the payment request signal. The encoded payment request signal may be passed from the communication controller 514 to the NFC transceiver 504 before it can be transmitted to the payment device 106 which is in communication with the transaction device 108-a through the NFC channel.

On the other hand, the payment authorization signal that the transaction device 108-a receives from the payment device 106 via the NFC transceiver 504 may be passed to the communication controller 514 through appropriate circuitries and physical connections which are well known in the art.

The communication controller 514 may perform a decoding operation 518 against the payment authorization signal. The decoded payment authorization signal may be passed from the communication controller 514 to the UART 510 which resides on the microcontroller 502.

At step 406, the vending apparatus 108 vends the commodity, which may be a product or a service, based on the commodity selection request signal from which the decoded payment authorization signal is originally derived.

The vending of the commodity based on the commodity selection by the purchaser is responsive to the receipt of the decoded payment authorization signal by the microcontroller 502 of the vending apparatus 108 from the transaction device 108-a.

If the commodity is a tangible product such as a containerized beverage, the microcontroller 502 may electronically transmit to the electromechanical controller 520 of the vending apparatus 108 a vending instruction to vend or dispense the tangible product from the vending apparatus 108.

The microcontroller 502 may also provide UART control 522 on the communication controller 514. The vending apparatus 108 may also include display and keypad components 524, 526.

The display component 524 enables the purchaser to view her selections and all information associated with the commodities offered for sale at the vending apparatus 108.

The keypad component 526 enables the purchaser to effectuate the selection of one or more commodities offered for sale at the vending apparatus 108.

In one embodiment, the transaction device 108-a of the vending apparatus 108 may be in communication with the payment processing system over any suitable wired or wireless communication channel. To allow this communication, the transaction device 108-a may be provided with an independent communication system or may be arranged to utilize the communication components of the microcontroller 502 of the vending apparatus 108 such as the modem 528, the wireless interface 530, the network interface 532, and the radio transceiver 534 having the radio antenna 536.

The payment authorization signal may also be received directly by the transaction device 108-a integrated into the vending apparatus 108 from the payment processing system over any suitable wireless communication channel or any suitable wired communication channel depending on its configuration.

It is to be understood and appreciated that the vending apparatus 108 may be equipped with other information handling resources such as MDB (multi-drop bus) and DEX (data exchange).

The MDB may serve as an internal communication protocol for allowing components of the vending apparatus 108 to properly and operably interface with any VMC (vending machine controller). The DEX may serve to extract and/or collect audit and event data from the vending apparatus 108 and format them for external use.

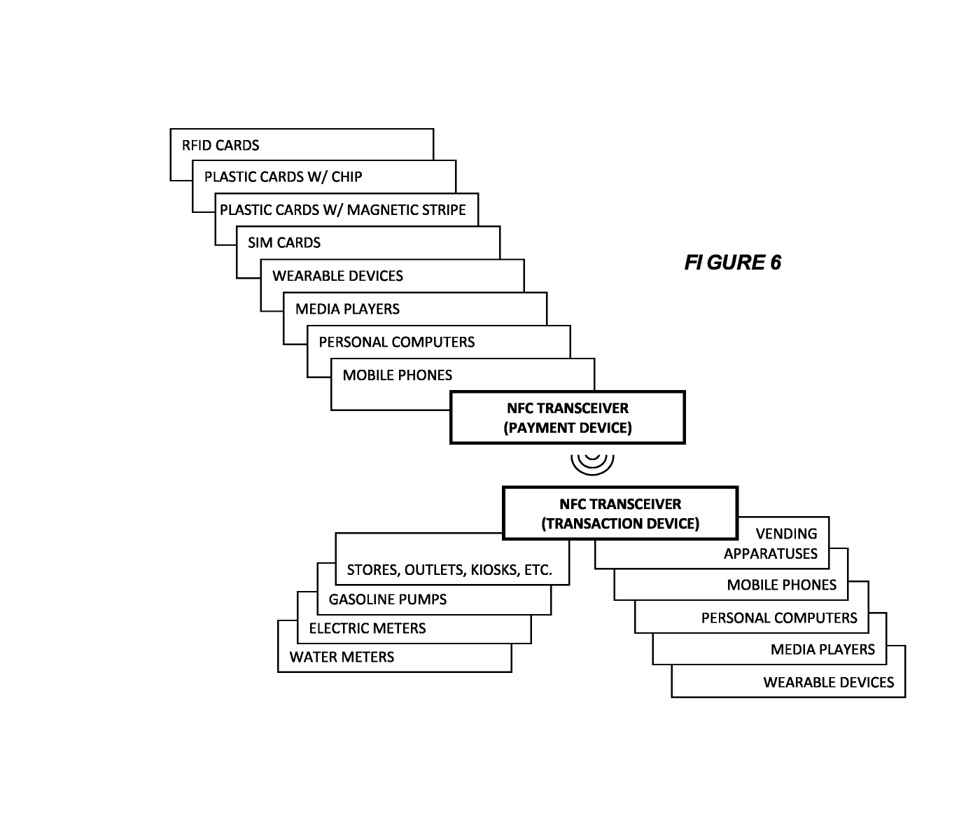

Referring now to FIG. 6, there is shown a conceptual diagram illustrating an example environment in which the POS system may be applied according to some embodiments of the disclosure of the present invention. The example environment shows non-limiting examples of some possible components of the POS system of the present invention apart from what has been mentioned and described above in great detail.

In some embodiments, the payment device of the POS system may include not only mobile phones but also personal computers, media players which may include digital televisions, wearable devices which may be wristwatch-type, patch-type or goggle-type, SIM cards, plastic cards with magnetic stripes, plastic cards with chips, and RFID cards, as long as they are NFC enabled or have NFC transceivers for performing incoming and outgoing NFC communications.

With regard to the mobile phone embodiment of the payment device, the payment application described in greater detail in FIG. 1 may be stored in any internal or external memory component of the mobile phone. In which case, the payment application may be executed from this memory component by a microprocessor component of the mobile device.

Alternatively, the payment application may also be arranged to be stored on a chip having a form factor of a dongle of any suitable size and configuration that is detachably attachable to any computing device preferably via a USB (Universal Serial Bus) interface which is well known in the art.

With regard to the SIM card embodiment of the payment device, the payment application may be stored on the memory component of the SIM card and may be executed from this memory component by a microprocessor component of the same SIM card.

The SIM card may be NFC enabled and may perform NFC communications independently of the mobile phone into which it is inserted. Alternatively, the SIM card may also utilize any pre-existing NFC transceiver or any other similar circuitries of the mobile phone for performing NFC communications.

In some embodiments, the transaction device of the POS system of the present invention may be suitably integrated not only into vending apparatuses but also to mobile phones, personal computers, media players, and wearable devices which may also be wristwatch-type, patch-type or goggle-type, as long as they have at least an NFC reader or NFC transceiver for receiving incoming NFC communications from the payment device.

In some embodiments, the transaction device of the POS system of the present invention may be suitably used in conjunction with any computing device or computing systems commonly used in physical facilities and/or structure wherein goods and/or services are offered for sale such as retail stores, retail outlets, kiosks, warehouses, garage areas, shops, malls, factories, gasoline pumps, electric meters, water meters, and the like.

While said computing devices or computing systems may not be configured to directly dispense any goods or services, they can be operated by human vendors who offer for sale any goods (e.g., grocery items, merchandise items, food items, and the like) or offer services (e.g., massage services, dental services, shipping services, patent drafting services, and the like) to receive payments.

For example, once a physical therapist has provided his client with a home-based and personalized therapeutic service, the client may use the payment application running on her NFC-enabled wearable wristwatch, or on a SIM card operatively coupled to her NFC-enabled wearable device, to pay for the therapeutic service she receives from the therapist.

To initialize the payment process, the therapist may use his NFC-enabled mobile phone to transmit a payment request signal to the wristwatch of the client by placing his mobile phone in close proximity to the NFC-enabled wristwatch. The wristwatch, through a pre-arranged NFC transceiver therein, may receive and read the payment request signal from the NFC-enabled mobile phone.

Tapping and/or swiping may also be possible for transmitting the payment request signal in the case of other embodiments of the payment device and depending on which device the NFC transceiver is operably coupled for NFC communications.

The payment request signal may contain account information associated with a deposit account of the therapist. The deposit account of the therapist is where his professional fee for the therapeutic service may be electronically deposited.

Upon receipt of the payment request signal, the payment application running on the wristwatch may be operated by the client to initiate and/or authorize either a front-end payment or back-end payment operation in real-time or near real-time.

As is well known, the front-end payment operation may be implemented by a front-end payment processor which is arranged for capturing, authorization and settlement with acquiring banks, which is connected to all card issuing companies, and which is configured to route transactions to an appropriate and/or predetermined network for authorization.

As is well known also, the back-end payment operation may be implemented by a back-end processor which is arranged to accept settlement from the front-end processor and which is configured to move funds from an issuing bank to an acquiring bank via central banking system or a regional bank.

The back-end payment operation, which effectively corresponds to a back-end payment authorization, is illustrated in FIG. 2, wherein the payment processing system, via a third party processor, processes the payment authorization and generates payment authorization signal for transmission to the payment device on which the payment application is operably installed.

The payment device may be configured to output the payment authorization signal at the moment it receives the same from the payment processing system.

In one embodiment, the payment operation which may include settlement and clearing operations may be characterized by: the wristwatch associating the account information with the payment request signal it receives from the mobile phone over the NFC channel; the wristwatch generating and transmitting to a payment processing system over the NFC channel a payment authorization request signal based on the associated account information and payment request signal; the payment processing system generating a payment authorization signal based on the payment authorization request signal it receives from the wristwatch; the payment processing system transmitting to the wristwatch the payment authorization signal over the packet-based communication channel; and the wristwatch transmitting to the mobile phone the payment authorization signal over the NFC channel.

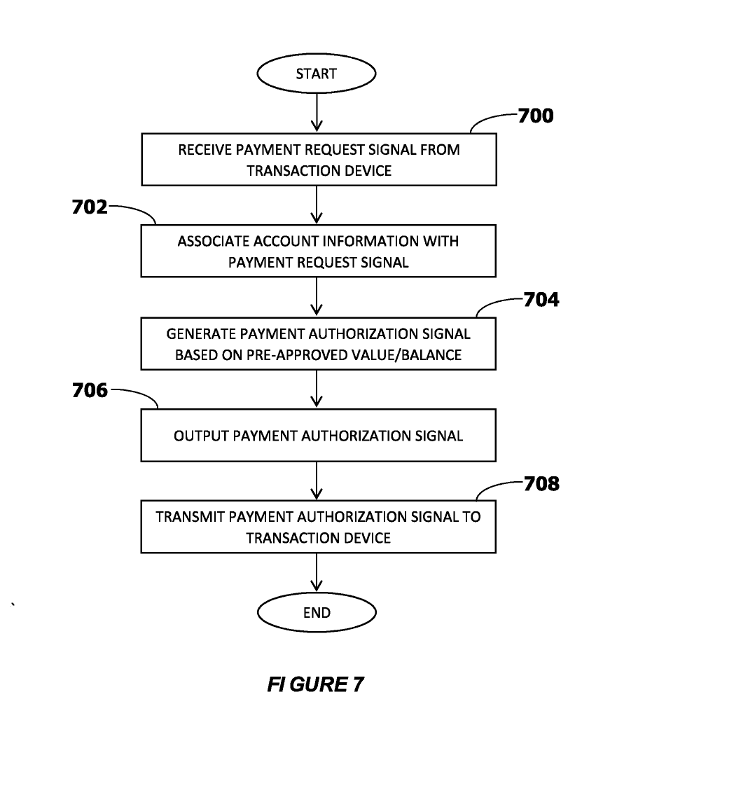

The front-end payment operation, which effectively corresponds to a front-end payment authorization, is shown in FIG. 7 which illustrates yet another exemplary computer-implemented process according to some embodiments of the disclosure of the present invention.

With more particularity, the process illustrated in FIG. 7 may be carried out or performed by the payment device which is illustrated in greater details in FIG. 1 through its hardware configuration illustrated in FIG. 3.

At step 700, the payment device receives payment request signal from the transaction device of the vending apparatus.

At step 702, the payment device associates account information with the payment request signal.

At step 704, the payment device, under the control of the client or user or purchaser, may be caused to generate payment authorization signal based on the associated account information and payment request signal. This payment authorization signal may be generated using pre-approved or pre-authorized value or balance associated with the financial account of the client.

The pre-approved value or balance is accessible to and viewable by the client on the display screen of the payment device, and the payment authorization for which can be performed using the payment application or payment application program.

At step 706, the payment device outputs the payment authorization signal generated based on the pre-approved value or balance associated with the financial account of the client.

At step 708, the payment device transmits the payment authorization signal to the transaction device integrated into the vending apparatus or any computing device which may serve as a transaction device in general or a POS device in particular.

Through well-known synchronization services, balances of the account of the client who serves as “payor” may be reflected in real-time or near real-time into the account information which are stored on the wristwatch and the corresponding account information which are stored on any banking computer system maintaining said account.

Synchronization services may automatically start whenever the wristwatch is in communication with the payment processing system via any suitable communication channel.

It now becomes apparent that the POS system of the present invention may be implemented in hardware, software, or any combination of hardware and software.

It also becomes apparent that the payment application may reside on any SIM card which may serve as a stand-alone payment device or, alternatively, which can be operatively coupled to any one of the non-exhaustive embodiments of the payment device including the RFID cards, plastic cards with chips or magnetic stripes, wearable devices, media players including television units, personal computers, and mobile phones.

The payment module which may include the payment application or payment application program of the POS system of the present invention may use conventional accounting and/or auditing system or, alternatively, any blockchain-based or any distributed ledger-based accounting and/or audit system.

The payment application or application program according to one aspect of the POS system of the present invention may also be arranged to generate conventional accounting statements such as general ledger, individual client ledger, balance sheet, cash flow statements, profit and loss reports, reconciliation reports, and earned income reports for any bank determined or otherwise user specified time periods. These information are preferably accessible to and viewable by a user on the display screen of her mobile device, or any computing device, in which the payment application or application program is operably installed.

While the present invention has been described with respect to a limited number of embodiments, those skilled in the art, having benefit of this disclosure, will appreciate that other embodiments can be devised which do not depart from the scope of the present invention as disclosed herein.

1. A point-of-sale system comprising:
at least one electronic account held at an electronic payment processing system;
a payment device in communication with the payment processing system over a first communication channel, the payment device comprising a memory component containing at least one account information relating to the account; and
a transaction device integrated into a commodity vending apparatus and in communication with the payment device over a second communication channel,
wherein the transaction device generates and transmits to the payment device a payment request signal based on a payment instruction from the vending apparatus, and
wherein, in response to receipt of the payment request signal from the transaction device, the payment device associates the at least one account information with the payment request signal, outputs a payment authorization signal based on the associated account information and payment request signal, and transmits to the transaction device the payment authorization signal.

2. The point-of-sale system according to claim 1, wherein, in response to receipt of the payment authorization signal from the payment device, the transaction device transmits to the vending apparatus the payment authorization signal.

3. The point-of-sale system according to claim 2, wherein, in response to receipt of the payment authorization signal from the transaction device, the vending apparatus vends a commodity.

4. The point-of-sale according to claim 1, wherein the payment authorization signal is generated by the payment device based on a pre-approved value associated with the account.

5. The point-of-sale according to claim 1, wherein, prior to outputting of the payment authorization signal, the payment device generates and transmits to the payment processing system a payment authorization request signal.

6. The point-of-sale according to claim 5, wherein, upon receipt of payment authorization request signal from the payment device, the payment authorization signal is generated and transmitted to the payment device by the payment processing system based on the payment authorization request signal.

7. The point-of-sale system according to claim 1, wherein the payment request signal includes any one or more of unique transaction identifier information, merchant account information, transaction date information, transaction time information, commodity description information, commodity quantity information, commodity price information, commodity tax information, and location information.

8. The point-of-sale system according to claim 1, wherein the account is a financial account at a financial institution.

9. The point-of-sale system according to claim 8, wherein the financial account is any one of a cash account, a credit account, a prepaid account, a savings account, a current account, a trust account, and an investment account.

10. The point-of-sale system according to claim 1, wherein the transaction device is in communication with the payment processing system over the first communication channel.

11. The point-of-sale system according to claim 10, wherein the payment authorization signal is received directly by the transaction device from the payment processing system.

12. The point-of-sale system according to claim 1, wherein the payment device includes a secure element.

13. The point-of-sale system according to claim 1, wherein the memory component is associated with the payment device.

14. The point-of-sale system according to claim 12, wherein the memory component is a secure element-based memory component associated with the secure element.

15. The point-of-sale system according to claim 1, wherein the first communication channel is a packet-based communication channel.

16. The point-of-sale system according to claim 1, wherein the second communication channel is a near field communication (NFC) channel.
